(19) United States
(12) Patent Application Publication
(10) Pub. No.: US 2019/0220999 A1
(43) Pub. Date: Jul. 18, 2019

(54) INSPECTION DEVICE

(71) Applicant: DENSO CORPORATION, Kariya-city (JP)

(72) Inventors: Katsuhiro MIYAGAKI, Kariya-city (JP); Kohei NAKAMURA, Kariya-city (JP); Masaru HORIGUCHI, Kariya-city (JP); Shinji KATO, Kariya-city (JP); Hiroyuki IWATSUKI, Kariya-city (JP)

(21) Appl. No.: 16/362,823

(22) Filed: Mar. 25, 2019

Related U.S. Application Data
(63) Continuation of application No. PCT/JP2017/034896, filed on Sep. 27, 2017.

(30) Foreign Application Priority Data
Sep. 28, 2016 (JP) 2016-190102

(51) Int. Cl. G06T 7/73; G06T 7/60

(52) U.S. Cl. CPC G06T 7/74; G06T 2207/30108; G06T 7/60

(57) ABSTRACT

An inspection device includes an image acquisition unit that acquires image data including an inspection object captured by a wearable camera, a deviation information acquisition unit that acquires deviation information for calculating at least one of: a deviation distance from a regulation distance of the inspection object in the image data, or a deviation angle from a regulation angle of the inspection object in the image data, and an image correction unit that calculates at least one of the deviation distance or the deviation angle based on the image data and the deviation information and corrects the image data.

### CROSS REFERENCE TO RELATED APPLICATIONS

The present application is a continuation application of International Patent Application No. PCT/JP2017/034896 filed on Sep. 27, 2017, which designated the United States and claims the benefit of priority from Japanese Patent Application No. 2016-190102 filed on Sep. 28, 2016. The entire disclosures of the above applications are incorporated herein by reference.

### TECHNICAL FIELD

The present disclosure relates to an inspection device.

### BACKGROUND

In the manufacturing process of a product, the quality of an object to be inspected such as a product at an intermediate stage (hereinafter referred to as “workpiece”) or a finished product may be visually inspected by a worker. In this case, a wearable camera may support the inspection work by capturing images.

### SUMMARY

An inspection device according to the present disclosure may include an image acquisition unit that acquires image data including an inspection object, the image data being captured by a wearable camera attached to a worker inspecting the inspection object, a deviation information acquisition unit that acquires deviation information for calculating at least one of: a deviation distance from a regulation distance of the inspection object in the image data, or a deviation angle from a regulation angle of the inspection object in the image data, and an image correction unit that calculates at least one of the deviation distance or the deviation angle based on the image data and the deviation information and corrects the image data.

### BRIEF DESCRIPTION OF DRAWINGS

FIG. 1 is a diagram for explaining a usage state of an inspection device according to a first embodiment.

FIG. 2 is a block configuration diagram showing the configuration of the inspection device shown in FIG. 1.

FIG. 3 is a block configuration diagram showing a functional configuration of a controller shown in FIG. 2.

FIG. 4 is a diagram for explaining image correction for an inspection device according to a first embodiment.

FIG. 5 is a diagram for explaining a usage state of an inspection device according to a second embodiment.

FIG. 6 is a block configuration diagram showing the configuration of the inspection device shown in FIG. 5.

FIG. 7 is a block configuration diagram showing a functional configuration of a controller shown in FIG. 6.

FIG. 8 is a diagram for explaining a usage state of an inspection device according to a third embodiment.

FIG. 9 is a block configuration diagram showing the configuration of the inspection device shown in FIG. 8.

FIG. 10 is a block configuration diagram showing a functional configuration of a controller shown in FIG. 9.

FIG. 11 is a diagram for explaining image correction for an inspection device according to a third embodiment.

FIG. 12 is a diagram for explaining image correction for an inspection device according to a third embodiment.

### DETAILED DESCRIPTION

Hereinafter, the present embodiments will be described with reference to the attached drawings. In order to facilitate the ease of understanding, the same reference numerals are attached to the same constituent elements in each drawing where possible, and redundant explanations are omitted.

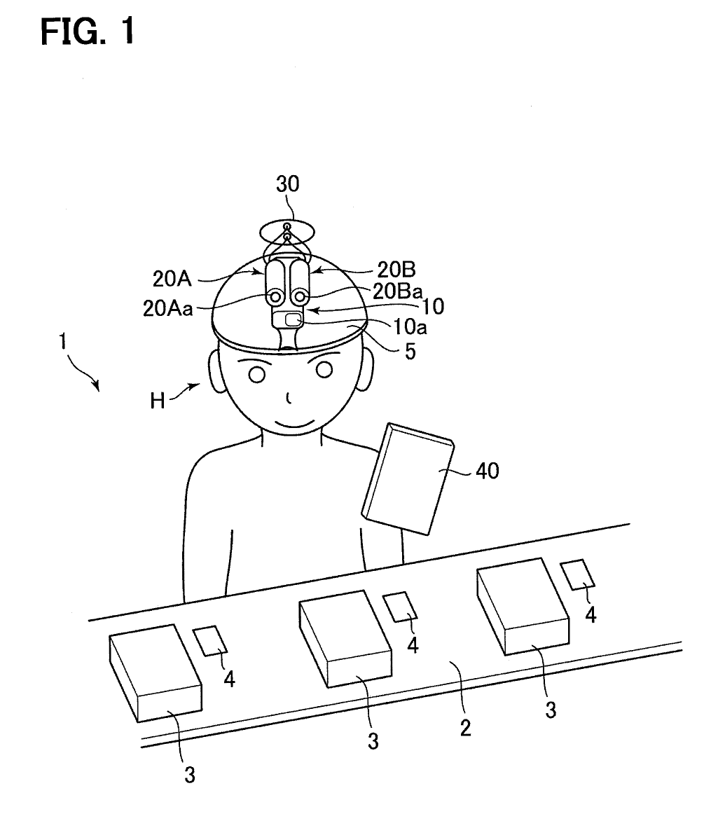

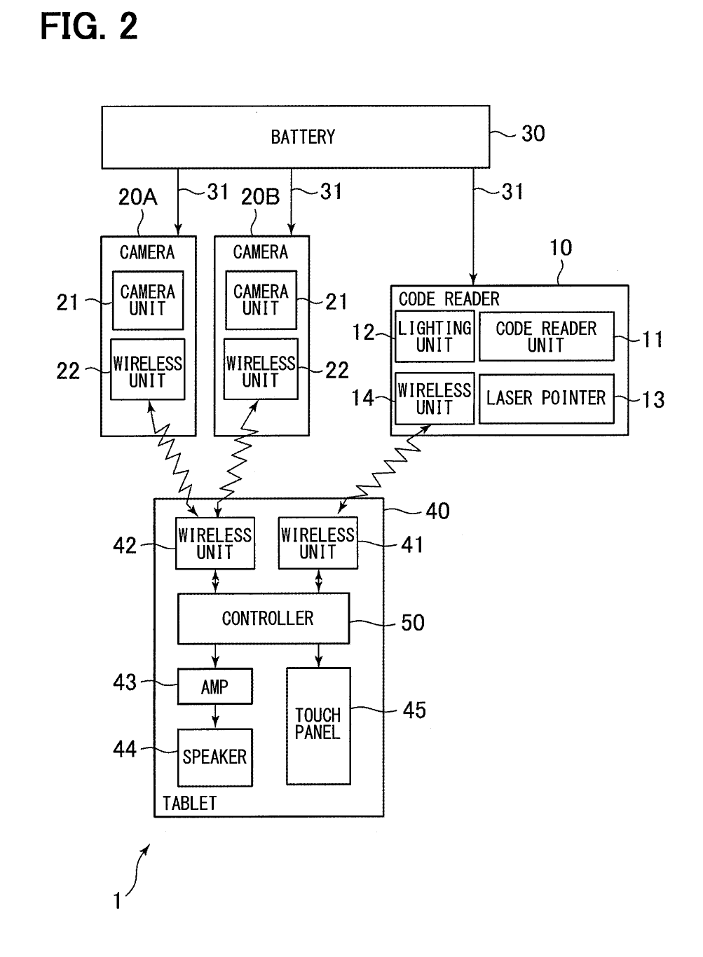

With reference to FIG. 1 and FIG. 2, an example of an inspection work to which an inspection device 1 according to a first embodiment is applied and a schematic configuration of the inspection device 1 will be described.

As shown in FIG. 1, the inspection device 1 according to the first embodiment is used in the manufacturing process of a product such as a heat exchanger. Specifically, the inspection device 1 is used in an inspection work for determining whether or not an object to be inspected, such as the workpiece 3 at an intermediate manufacturing stage or a finished product, are good products.

A worker H of the inspection work inspects whether or not the workpieces 3 sequentially conveyed by a conveyor 2 are good. On the conveyor 2, a plurality of sets of workpieces 3 and signboards 4 are placed. The conveyor 2 conveys these sets so that a plurality of the sets are sequentially arranged in front of the workers H. The signboard 4 is arranged near its corresponding workpiece 3, and a code indicating the type of the workpiece 3 is displayed on that signboard 4.

The worker H can perform the above-described inspection work using the inspection device 1 of the present embodiment. As shown in FIGS. 1 and 2, the inspection device 1 includes a code reader 10, wearable cameras 20A, 20B, a battery 30, and a tablet 40.

As shown in FIG. 2, the code reader 10 includes a code reader unit 11, a lighting unit 12, a laser pointer unit 13, and a wireless unit 14.

The code reader unit 11 a well known optical code reader including a light source that irradiates light. Light is emitted from the light source through lens 10a, reflected by the signboard 4, and received through the lens 10a. The code reader unit 11 reads this reflected light to read codes. Here, the signboard 4 of the present embodiment is a display board on which a code is displayed. The code is an identification indicator indicating the type of the workpiece 3. Various codes, such as a QR code (registered trademark) or a bar code, may be used as the code.

The lighting unit 12 illuminates the workpiece 3 and its surroundings through the lens 10a.

The laser pointer unit 13 irradiates a laser beam as a pointer through the lens 10a. Thus, the laser pointer unit 13 assists the worker H to recognize a target reading area in which the code reader unit 11 reads codes. In the present embodiment, the region irradiated with the laser beam by the laser pointer unit 13 is set to coincide with the target reading area of the code reader unit 11.

The wireless unit 14 is composed of an antenna, a wireless circuit, and the like, and wirelessly communicates with the wireless unit 41 of the tablet 40.

The wearable cameras 20A, 20B are compact cameras which are attached to a body or the like and are intended to capture images in a hands-free manner. The wearable camera 20A and the wearable camera 20B are arranged in parallel at equal height to each other and synchronized with each other. The wearable camera 20A and the wearable camera 20B form a stereo camera. As shown in FIG. 2, each of the wearable cameras 20A, 20B includes a camera unit 21 and a wireless unit 22. The camera units 21 capture images of the workpiece 3 as an target imaging object using the light received via lens 20Aa, 20Ba. The wireless unit 22 is composed of an antenna, a wireless circuit, and the like, and wirelessly communicates with the wireless unit 42 of the tablet 40.

The battery 30 is a secondary battery that supplies direct current power to the code reader 10 and the wearable cameras 20A, 20B via a harness 31 or the like.

In the present embodiment, as shown in FIG. 1, the code reader 10, the wearable cameras 20A, 20B, and the battery 30 are mounted on a hat 5 to be worn by the worker H. Further, the code reader 10 and the wearable cameras 20A, 20B are installed on the hat 5 of the worker H so that the lens 10a of the code reader 10 and the lens 20Aa, 20Ba of the wearable cameras 20A, 20B are disposed facing the front of the worker H.

The tablet 40 is a portable terminal configured to be carried by the worker H. As shown in FIG. 2, the tablet 40 includes wireless units 41 and 42, an amplifier 43, a speaker 44, a touch panel 45, and a controller 50.

The wireless units 41 and 42 are composed of an antenna, a wireless circuit, and the like. The wireless unit 41 wirelessly communicates with the wireless unit 14 of the code reader 10. The wireless unit 42 wirelessly communicates with the wireless units 22 of the wearable cameras 20A, 20B. In the present embodiment, various types of short range wireless communications may be used for wireless communication between the wireless units. Bluetooth (registered trademark) or Wi-Fi (registered trademark) can be used as the short-range wireless communication.

The amplifier 43 amplifies the voltage of the analog signal output from the controller 50 and outputs an amplified signal. The speaker 44 converts the amplified signal output from the amplifier 43 into sound and outputs the sound. The touch panel 45 is a display device combining a transparent key input operation unit and a display panel.

The controller 50 is a device that controls the operation of each part of the inspection device 1 related to the above-described inspection work. The controller 50 is physically a microcontroller composed of a CPU, a memory, digital-analog conversion circuits, and the like. The controller 50 executes an inspection process in accordance with a computer program stored in advance in the memory. The inspection process is a determination process of determining whether or not the workpiece 3 is a non-defective product based on the code acquired from the code reader 10 and the captured images acquired by the wearable cameras 20A, 20B.

In the memory, a plurality of kinds of reference images are stored in advance. The reference images include still images or videos, and are used for determining whether or not the workpiece 3 is a non-defective item. Each reference image includes a non-defective product image showing a workpiece 3 which is a non-defective product and a defective product image showing a defective workpiece 3. The digital-analog conversion circuit outputs an analog signal representing a sound based on a command of the CPU.

In the present embodiment, the tablet 40 is carried by the worker H, for example, stored in a pocket of the worker H, or is placed in the vicinity of the worker H.

By using the inspection device 1 configured in this way, the standard work for the inspection process for the workpiece 3 as performed by the worker H may be, for example, performed as follows.

First, the worker H directs their head to face the signboard 4, so that the code reader 10 attached to the hat 5 reads the code from the signboard 4. Next, the head is directed to face the workpiece 3, and the wearable cameras 20A, 20B attached to the hat 5 likewise captures the image of the workpiece 3 to acquire the captured images. That is, using the code reader 10 reading the code from the signboard 4 as a trigger, the wearable cameras 20A, 20B acquire the captured images of the workpiece 3. The tablet 40 receives the code from the code reader 10 via wireless communication and receives the captured images from the wearable cameras 20A, 20B.

The controller 50 in the tablet 40 selects the reference image corresponding to the received code from the plurality of types of reference images stored in advance in the memory as described above. The controller 50 compares the captured image of the workpiece 3 with the reference image to determine whether or not the workpiece 3 is a non-defective product. In addition, the controller 50 notifies the worker H of the result of pass/fail determination of the workpiece 3 via sound information or visual information using the speaker 44 of the tablet 40 or the touch panel 45 of the tablet 40.

The worker H continues to the next work based on the information of the determination result outputted from the tablet 40. For example, if it is determined that the workpiece 3 is a non-defective product, the next workpiece 3 on the conveyor 2 is inspected.

The inspection device 1 configured as described above is carried by the worker H as a wearable device so that both hands of the worker H are free. With the above configuration, the inspection device 1 can automatically perform the inspection work for the inspection object without requiring any operation using the hands of the worker H, and supports the inspection work of the worker H so that the burden on the worker H can be reduced. In addition, since the worker H is in a hands-free state during the inspection work, the worker H can perform other work (such as screw tightening) aside from the inspection while performing the inspection work of the workpiece 3, and efficiency can be improved.

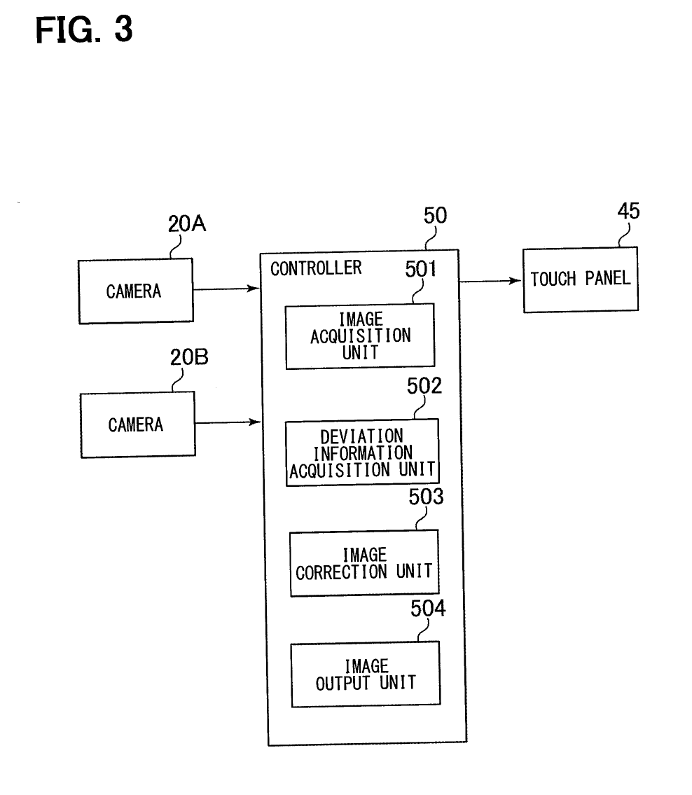

Next, functional components of the controller 50 and their operations will be described with reference to FIG. 3. The controller 50 includes, as functional components, an image acquisition unit 501, a deviation information acquisition unit 502, an image correction unit 503, and an image output unit 504.

The image acquisition unit 501 acquires image data output from the wearable cameras 20A, 20B. The wearable camera 20A and the wearable camera 20B are arranged in parallel at equal height to each other and synchronized with each other. Accordingly, the output image data is also acquired in a synchronized manner.

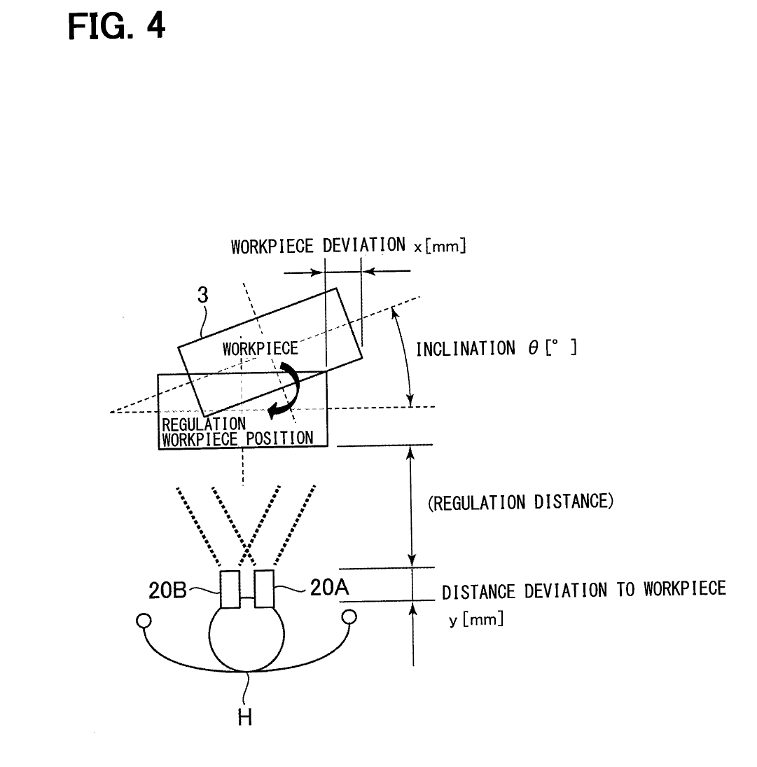

The deviation information acquisition unit 502 acquires deviation information for calculating at least one of: a deviation distance from a regulation distance of the workpiece 3 in the image data, or a deviation angle from a regulation angle of the workpiece 3. Specifically, as shown in FIG. 4, if the workpiece 3 deviates from the regulation workpiece position, the above described inspection may not be performed accurately in some cases. Therefore, image data and synchronization information output from the wearable cameras 20A and 20B are acquired and used as information for calculating an inclination 8, a workpiece horizontal deviation x, and a workpiece vertical deviation y for the workpiece 3 with respect to the regulation workpiece position.

Since the wearable cameras 20A and 20B are arranged so as to form a stereo camera, it is possible to calculate the inclination 8, the workpiece horizontal deviation x, and the workpiece vertical deviation y for the workpiece 3 with respect to the regulation workpiece position by calculating the position and distance of at least two representative points in the image data captured by the wearable cameras 20A and 20B. The image data captured by the wearable camera 20A is a main image data, and the image data captured by the wearable camera 20B is an auxiliary image data. Therefore, the wearable camera 20B functions as an auxiliary wearable camera.

The image correction unit 503 calculates at least one of the deviation distance or the deviation angle based on the image data and the deviation information, and corrects the image data. Specifically, the image correction unit 503 calculates at least one of the deviation distance or the deviation angle from the parallax of the inspection object in the image data and the auxiliary image data. In the example shown in FIG. 4, the workpiece 3 is corrected so as to be at the regulation workpiece position.

The image output unit 504 outputs the corrected image data, which is corrected by the image correction unit 503, to the touch panel 45. The touch panel 45 displays the corrected image data.

As described above, an inspection device 1 according to the first embodiment includes the image acquisition unit 501 that acquires image data including the inspection target workpiece 3, the image data being captured by the wearable cameras 20A, 20B attached to the worker H inspecting the workpiece 3, the deviation information acquisition unit 502 that acquires deviation information for calculating at least one of: the deviation distances x, y from the regulation distance of the workpiece 3 in the image data, or the deviation angle θ from the regulation angle of the workpiece 3 in the image data, and the image correction unit 503 that calculates at least one of the deviation distances x, y or the deviation angle θ based on the image data and the deviation information and corrects the image data.

In the present embodiment, at least one of the deviation distances x, y or the deviation angle θ is calculated based on the image data and the deviation information, and the image data is corrected. Therefore, even if the workpiece 3 is deviated from the regulation position, it is possible to correct the position of the workpiece 3 so as to correspond to a predetermined position. Specifically, in reality, due to differences in how to arrange the objects to be inspected on the inspection table, or due to variations in the angle of each worker with respect to the object to be inspected, it is difficult to ensure a predetermined distance and a predetermined angle. In this regard, the inspection device 1 of the present disclosure is capable of accurately inspecting the workpiece 3 even when the worker H can not ensure a predetermined angle and a predetermined distance with respect to the workpiece 3.

According to inspection device 1, the deviation information acquisition unit 502 acquires auxiliary image data including the inspection target workpiece 3, which is imaged by the wearable camera 20B as an auxiliary wearable camera arranged in parallel and at equal height with the wearable camera 20A. Further, the image correction unit 503 calculates at least one of the deviation distance x, the deviation distance y, or the deviation angle θ from the parallax of the workpiece 3 in the image data captured by the wearable camera 20A and the auxiliary image data captured by the wearable camera 20B.

At least one of the deviation distances x, y or the deviation angle θ is calculated from the parallax based on the image data and the auxiliary image data captured by the wearable cameras 20A and 20B configured as a stereo camera. Accordingly, it is possible to more accurately correct the image data.

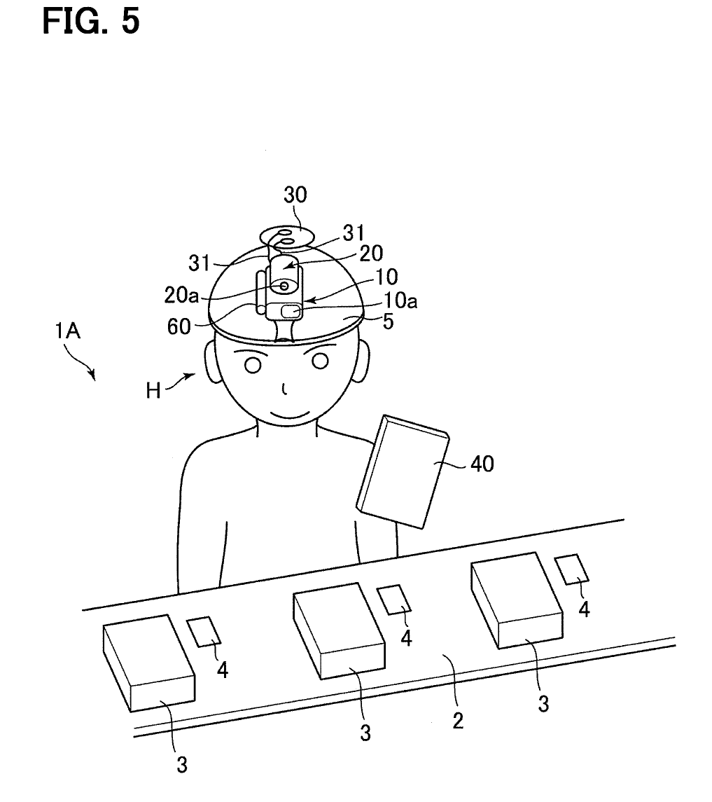

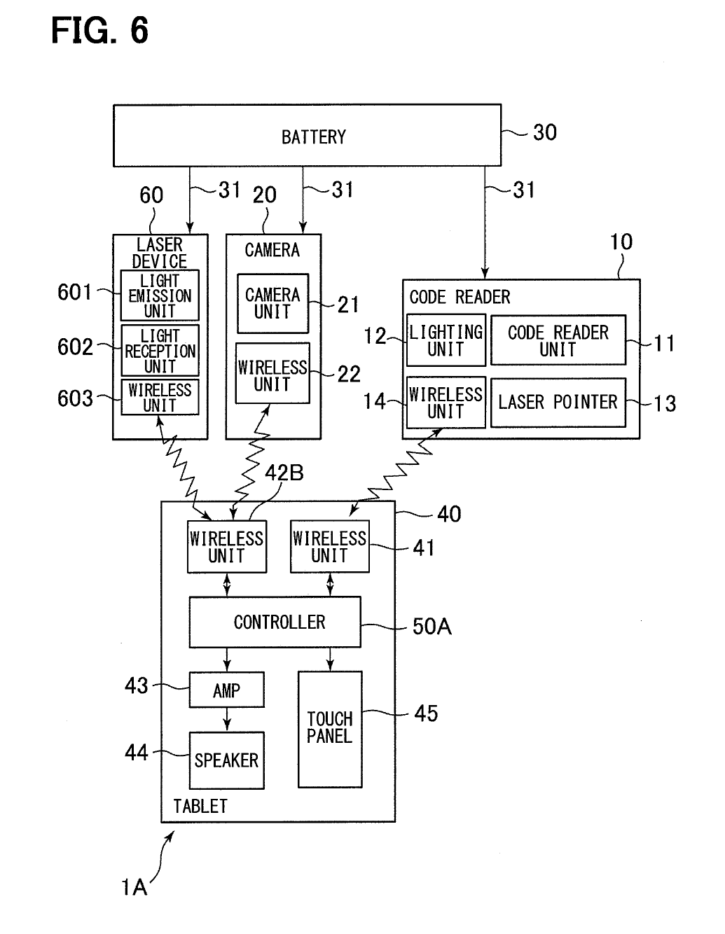

An inspection device 1A according to a second embodiment will be described with reference to FIGS. 5 and 6. An example of the inspection work to which the inspection device 1A is applied is the same as the inspection device 1 according to the first embodiment, so description thereof will be omitted.

The inspection device 1A includes a code reader 10, a wearable camera 20, a battery 30, a laser device 60, and a tablet 40. The code reader 10 and the battery 30 are the same as those in the first embodiment, so descriptions thereof will be omitted. With respect to the other constituent elements, descriptions of portions common to those of the first embodiment will be omitted.

The wearable camera 20 is a compact camera which is attached to a body or the like and is intended to capture images in a hands-free manner. As shown in FIG. 6, the wearable camera 20 includes a camera unit 21 and a wireless unit 22. The camera unit 21 captures images of the workpiece 3 as an target imaging object using the light received via lens 20a. The wireless unit 22 is composed of an antenna, a wireless circuit, and the like, and wirelessly communicates with the wireless unit 42B of the tablet 40.

The laser device 60 is a device for measuring a distance to the workpiece 3. The laser device 60 includes a light emission unit 601, a light reception unit 602, and a wireless unit 603. The laser light emitted from the light emission unit 601 is reflected by the workpiece 3. The laser light emitted from the light emission unit 601 is a distance measuring light emitted at a predetermined angle to the optical axis of the wearable camera 20.

The laser beam reflected by the workpiece 3 is received by the light reception unit 602. It is possible to measure the distance to the workpiece 3 based on the timing at which the light emission unit 601 emits the laser light and the timing at which the light reception unit 602 receives the laser light. Information on the distance to the workpiece 3 is transmitted from the wireless unit 603 to the wireless unit 42B of the tablet 40.

The tablet 40 is a portable terminal configured to be carried by the worker H. As shown in FIG. 6, the tablet 40 includes wireless units 41 and 42B, an amplifier 43, a speaker 44, a touch panel 45, and a controller 50A.

The wireless units 41 and 42B are composed of an antenna, a wireless circuit, and the like. The wireless unit 41 wirelessly communicates with the wireless unit 14 of the code reader 10. The wireless unit 42B wirelessly communicates with the wireless unit 22 of the wearable camera 20 and the wireless unit 603 of the laser device 60.

The amplifier 43 amplifies the voltage of the analog signal output from the controller 50A and outputs an amplified signal. The speaker 44 converts the amplified signal output from the amplifier 43 into sound and outputs the sound. The touch panel 45 is a display device combining a transparent key input operation unit and a display panel.

The controller 50A is a device that controls the operation of each part of the inspection device 1A related to the above-described inspection work. The controller 50A is physically a microcontroller composed of a CPU, a memory, digital-analog conversion circuits, and the like. The controller 50A executes an inspection process in accordance with a computer program stored in advance in the memory. The inspection process is a determination process of determining whether or not the workpiece 3 is a non-defective product based on the code acquired from the code reader 10 and the captured image acquired by the wearable camera 20.

In the memory, a plurality of kinds of reference images are stored in advance. The reference images include still images or videos, and are used for determining whether or not the workpiece 3 is a non-defective item. Each reference image includes a non-defective product image showing a workpiece 3 which is a non-defective product and a defective product image showing a defective workpiece 3. The digital-analog conversion circuit outputs an analog signal representing a sound based on a command of the CPU.

In the present embodiment, the tablet 40 is carried by the worker H, for example, stored in a pocket of the worker H, or is placed in the vicinity of the worker H.

By using the inspection device 1A configured in this way, the standard work for the inspection process for the workpiece 3 as performed by the worker H may be, for example, performed as follows.

First, the worker H directs their head to face the signboard 4, so that the code reader 10 attached to the hat 5 reads the code from the signboard 4. Next, the head is directed to face the workpiece 3, and the wearable camera 20 attached to the hat 5 likewise captures the image of the workpiece 3 to acquire the captured image. That is, using the code reader 10 reading the code from the signboard 4 as a trigger, the wearable camera 20 acquires the captured image of the workpiece 3. The tablet 40 receives the code from the code reader 10 via wireless communication and receives the captured image from the wearable camera 20.

The controller 50A in the tablet 40 selects the reference image corresponding to the received code from the plurality of types of reference images stored in advance in the memory as described above. The controller 50A compares the captured image of the workpiece 3 with the reference image to determine whether or not the workpiece 3 is a non-defective product. In addition, the controller 50A notifies the worker H of the result of pass/fail determination of the workpiece 3 via sound information or visual information using the speaker 44 of the tablet 40 or the touch panel 45 of the tablet 40.

The worker H continues to the next work based on the information of the determination result outputted from the tablet 40. For example, if it is determined that the workpiece 3 is a non-defective product, the next workpiece 3 on the conveyor 2 is inspected.

The inspection device 1A configured as described above is carried by the worker H as a wearable device so that both hands of the worker H are free. With the above configuration, the inspection device 1A can automatically perform the inspection work for the inspection object without requiring any operation using the hands of the worker H, and supports the inspection work of the worker H so that the burden on the worker H can be reduced. In addition, since the worker H is in a hands-free state during the inspection work, the worker H can perform other work (such as screw tightening) aside from the inspection while performing the inspection work of the workpiece 3, and efficiency can be improved.

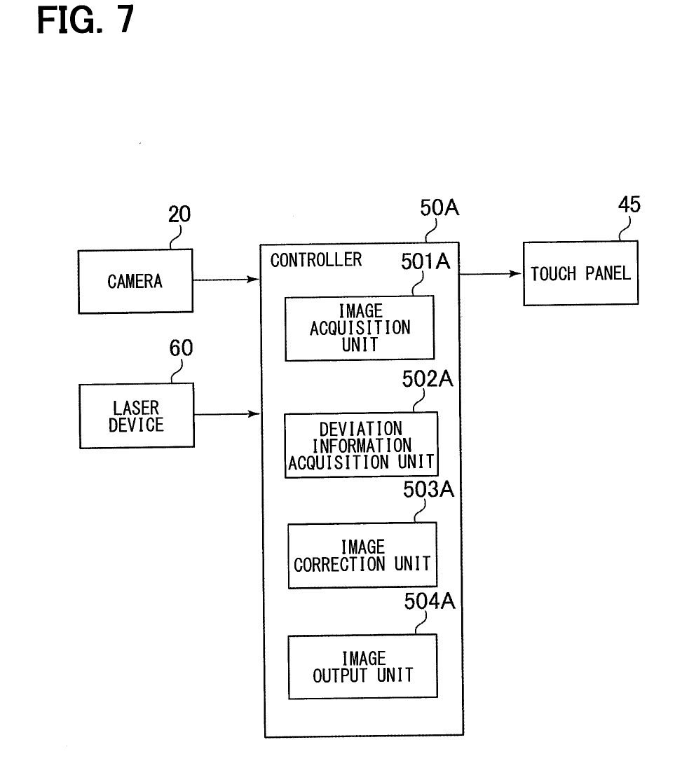

Next, functional components of the controller 50A and their operations will be described with reference to FIG. 7. The controller 50A includes, as functional components, an image acquisition unit 501A, a deviation information acquisition unit 502A, an image correction unit 503A, and an image output unit 504A.

The image acquisition unit 501A acquires image data output from the wearable camera 20.

The deviation information acquisition unit 502A acquires deviation information for calculating at least one of: a deviation distance from a regulation distance of the workpiece 3 in the image data, or a deviation angle from a regulation angle of the workpiece 3. Specifically, the distance to the workpiece 3 measured by the laser device 60 is used as the deviation information.

The image correction unit 503A calculates at least one of the deviation distance or the deviation angle based on the image data and the deviation information, and corrects the image data. Specifically, the image correction unit 503A calculates at least one of the deviation distance or the deviation angle from the parallax of the inspection object in the image data and the auxiliary image data.

The image output unit 504A outputs the corrected image data, which is corrected by the image correction unit 503A, to the touch panel 45. The touch panel 45 displays the corrected image data.

As described above, an inspection device 1A according to the second embodiment includes the image acquisition unit 501A that acquires image data including the inspection target workpiece 3, the image data being captured by the wearable camera 20 attached to the worker H inspecting the workpiece 3, the deviation information acquisition unit 502A that acquires deviation information for calculating at least one of: the deviation distances x, y from the regulation distance of the workpiece 3 in the image data, or the deviation angle θ from the regulation angle of the workpiece 3 in the image data, and the image correction unit 503A that calculates at least one of the deviation distances x, y or the deviation angle θ based on the image data and the deviation information and corrects the image data.

In the present embodiment, at least one of the deviation distances x y or the deviation angle θ is calculated based on the image data and the deviation information, and the image data is corrected. Therefore, even if the workpiece 3 is deviated from the regulation position, it is possible to correct the position of the workpiece 3 so as to correspond to a predetermined position.

According to inspection device 1A, the deviation information acquisition unit 502A acquires distance information on the inspection target workpiece 3 based on the laser light, which is a distance measurement light, emitted at a predetermined angle to the optical axis of the wearable camera 20. Further, the image correction unit 503A calculates at least one of the deviation distance or the deviation angle from the image data and the distance information.

Since it is possible to specify the distance and angle of a specific part of the image data based on the image data and the distance information, it is possible to calculate at least one of the deviation distances x, y or the deviation angle θ, and more accurately correct the image data.

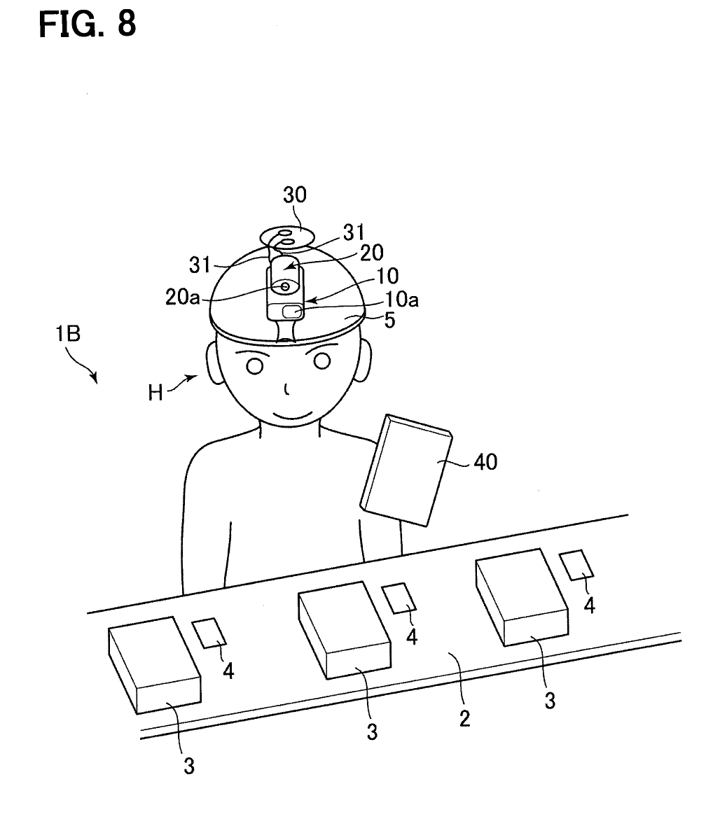

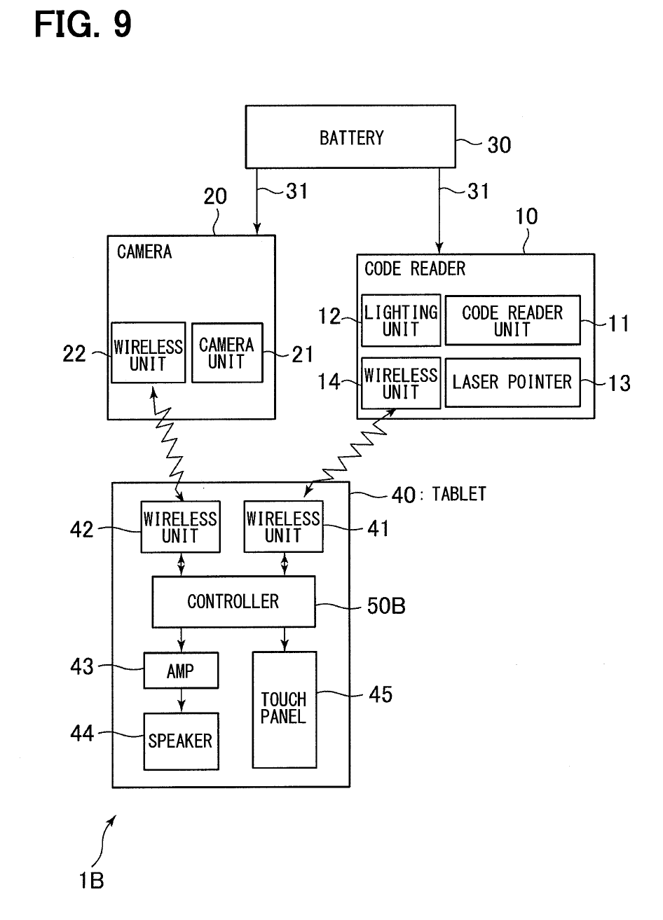

An inspection device 1B according to a third embodiment will be described with reference to FIGS. 8 and 9. An example of the inspection work to which the inspection device 1B is applied is the same as the inspection device 1 according to the first embodiment, so description thereof will be omitted.

The inspection device 1B includes a code reader 10, a wearable camera 20, a battery 30, and a tablet 40. The code reader 10 and the battery 30 are the same as those in the first embodiment, so descriptions thereof will be omitted. With respect to the other constituent elements, descriptions of portions common to those of the first embodiment will be omitted.

The wearable camera 20 is a compact camera which is attached to a body or the like and is intended to capture images in a hands-free manner. As shown in FIG. 9, the wearable camera 20 includes a camera unit 21 and a wireless unit 22. The camera unit 21 captures images of the workpiece 3 as an target imaging object using the light received via lens 20a. The wireless unit 22 is composed of an antenna, a wireless circuit, and the like, and wirelessly communicates with the wireless unit 42 of the tablet 40.

The tablet 40 is a portable terminal configured to be carried by the worker H. As shown in FIG. 9, the tablet 40 includes a wireless unit 41, an amplifier 43, a speaker 44, a touch panel 45, and a controller 50B.

The amplifier 43 amplifies the voltage of the analog signal output from the controller 50B and outputs an amplified signal. The speaker 44 converts the amplified signal output from the amplifier 43 into sound and outputs the sound. The touch panel 45 is a display device combining a transparent key input operation unit and a display panel.

The controller 50B is a device that controls the operation of each part of the inspection device 1B related to the above-described inspection work. The controller 50B is physically a microcontroller composed of a CPU, a memory, digital-analog conversion circuits, and the like. The controller 50B executes an inspection process in accordance with a computer program stored in advance in the memory. The inspection process is a determination process of determining whether or not the workpiece 3 is a non-defective product based on the code acquired from the code reader 10 and the captured image acquired by the wearable camera 20.

In the memory, a plurality of kinds of reference images are stored in advance. The reference images include still images or videos, and are used for determining whether or not the workpiece 3 is a non-defective item. Each reference image includes a non-defective product image showing a workpiece 3 which is a non-defective product and a defective product image showing a defective workpiece 3. The digital-analog conversion circuit outputs an analog signal representing a sound based on a command of the CPU.

In the present embodiment, the tablet 40 is carried by the worker H, for example, stored in a pocket of the worker H, or is placed in the vicinity of the worker H.

By using the inspection device 1B configured in this way, the standard work for the inspection process for the workpiece 3 as performed by the worker H may be, for example, performed as follows.

First, the worker H directs their head to face the signboard 4, so that the code reader 10 attached to the hat 5 reads the code from the signboard 4. Next, the head is directed to face the workpiece 3, and the wearable camera 20 attached to the hat 5 likewise captures the image of the workpiece 3 to acquire the captured image. That is, using the code reader 10 reading the code from the signboard 4 as a trigger, the wearable camera 20 acquires the captured image of the workpiece 3. The tablet 40 receives the code from the code reader 10 via wireless communication and receives the captured image from the wearable camera 20.

The controller 50B in the tablet 40 selects the reference image corresponding to the received code from the plurality of types of reference images stored in advance in the memory as described above. The controller 50B compares the captured image of the workpiece 3 with the reference image to determine whether or not the workpiece 3 is a non-defective product. In addition, the controller 50B notifies the worker H of the result of pass/fail determination of the workpiece 3 via sound information or visual information using the speaker 44 of the tablet 40 or the touch panel 45 of the tablet 40.

The worker H continues to the next work based on the information of the determination result outputted from the tablet 40. For example, if it is determined that the workpiece 3 is a non-defective product, the next workpiece 3 on the conveyor 2 is inspected.

The inspection device 1B configured as described above is carried by the worker H as a wearable device so that both hands of the worker H are free. With the above configuration, the inspection device 1B can automatically perform the inspection work for the inspection object without requiring any operation using the hands of the worker H, and supports the inspection work of the worker H so that the burden on the worker H can be reduced. In addition, since the worker H is in a hands-free state during the inspection work, the worker H can perform other work (such as screw tightening) aside from the inspection while performing the inspection work of the workpiece 3, and efficiency can be improved.

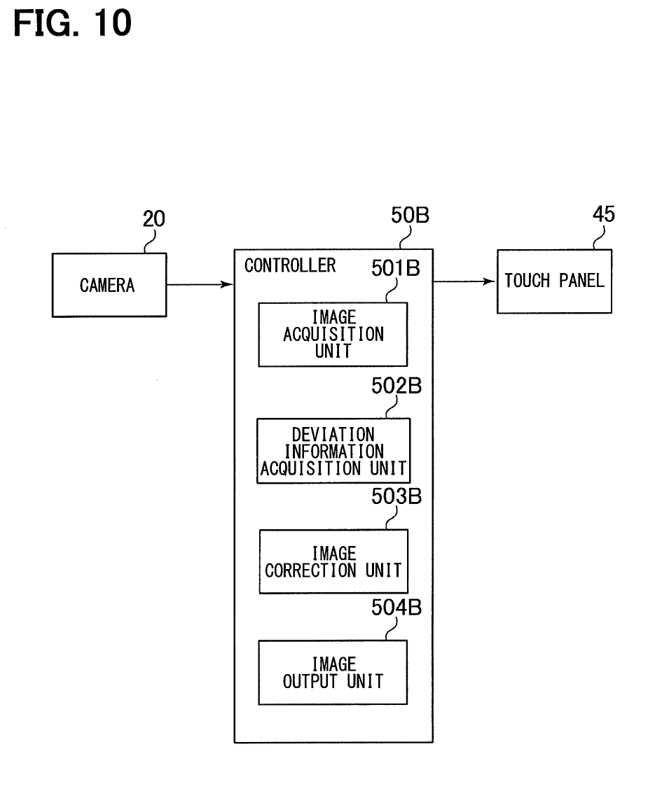

Next, functional components of the controller 50B and their operations will be described with reference to FIG. 10. The controller 50B includes, as functional components, an image acquisition unit 501B, a deviation information acquisition unit 502B, an image correction unit 503B, and an image output unit 504B.

The image acquisition unit 501B acquires image data output from the wearable camera 20.

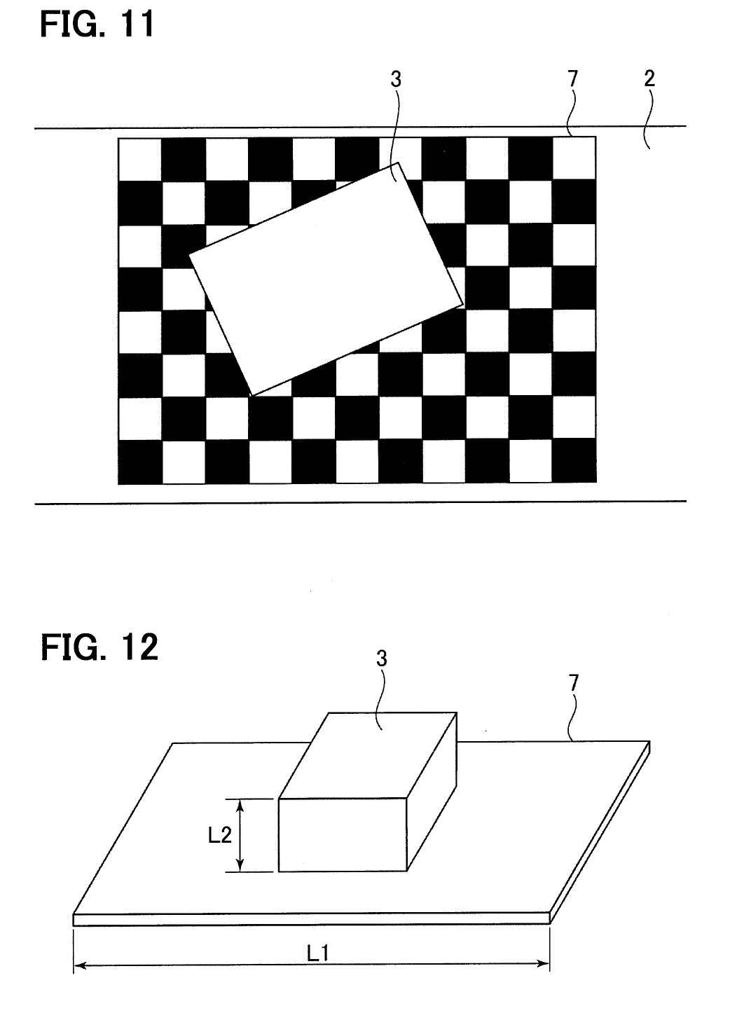

The deviation information acquisition unit 502B acquires deviation information for calculating at least one of: a deviation distance from a regulation distance of the workpiece 3 in the image data, or a deviation angle from a regulation angle of the workpiece 3. Specifically, as shown in FIG. 11, position specifying information from the pallet 7 on which the workpiece 3 is placed is acquired as the deviation information. Black squares and white squares are alternately arranged in a lattice pattern on the pallet 7. Therefore, for example, it can be specified that the front left corner of the workpiece 3 is positioned 3 squares from the left and 2 squares from the front. In this case, the number of squares to the specific position of the workpiece 3 is the position specifying information. As another example, as shown in FIG. 12, it is also possible to calculate a measurement target dimension L2 based on the known dimension L1 of the pallet 7 and the ratio between the known dimension L1 of the pallet 7 and the measurement target dimension L2 of the workpiece 3. In this case, the ratio between the known dimension L1 of the pallet 7 and the measurement target dimension L2 of the workpiece 3 is the position specifying information.

The image correction unit 503B calculates at least one of the deviation distance or the deviation angle based on the image data and the deviation information, i.e., the position specifying information, and corrects the image data.

The image output unit 504B outputs the corrected image data, which is corrected by the image correction unit 503B, to the touch panel 45. The touch panel 45 displays the corrected image data.

As described above, an inspection device 1B according to the third embodiment includes the image acquisition unit 501B that acquires image data including the inspection target workpiece 3, the image data being captured by the wearable camera 20 attached to the worker H inspecting the workpiece 3, the deviation information acquisition unit 502B that acquires deviation information for calculating at least one of: the deviation distances x, y from the regulation distance of the workpiece 3 in the image data, or the deviation angle θ from the regulation angle of the workpiece 3 in the image data, and the image correction unit 503B that calculates at least one of the deviation distances x, y or the deviation angle θ based on the image data and the deviation information and corrects the image data.

In the present embodiment, at least one of the deviation distances x, y or the deviation angle θ is calculated based on the image data and the deviation information, and the image data is corrected. Therefore, even if the workpiece 3 is deviated from the regulation position, it is possible to correct the position of the workpiece 3 so as to correspond to a predetermined position.

Further, in the inspection device 1B, the deviation information acquisition unit 502B acquires, as deviation information, position specifying information imaged together with the inspection target workpiece 3 in the image data. Then, the image correction unit 503B calculates at least one of the deviation distance or the deviation angle from the relative positional relationship between the workpiece 3 and the position specifying information.

Since the position specifying information imaged together with the inspection target workpiece 3 in the image data is acquired as deviation information, it is possible to calculate at least one of the deviation distance or the deviation angle with just a monocular camera.

In the present embodiment, the position specifying information is a lattice-shaped pattern on the portion where the workpiece 3 is placed. By using a lattice-shaped pattern as shown in FIG. 11, position specifying information can be obtained by counting the number of lattices up to the portion where the pattern is visibly obscured.

Further, in the present embodiment, the position specifying information is known shape information in a portion where the workpiece 3 is placed. As shown in FIG. 12, by calculating the ratio between the dimension L1 of the pallet 7, which is the known shape information, and the dimension L2 of the measurement target portion of the workpiece 3, it is possible to specify the arrangement position of the workpiece 3 with respect to the pallet 7.

The present embodiment has been described above with reference to the specific examples. However, the present disclosure is not limited to those specific examples. Those specific examples subjected to an appropriate design change by those skilled in the art are also encompassed in the scope of the present disclosure as long as the changed examples have the features of the present disclosure. Each element included in each of the specific examples described above and the placement, condition, shape, and the like of each element are not limited to those illustrated, and can be changed as appropriate. The combinations of elements included in each of the above described specific examples can be appropriately modified as long as no technical inconsistency occurs.

1. An inspection device, comprising:
an image acquisition unit that acquires image data including an inspection object, the image data being captured by a wearable camera attached to a worker inspecting the inspection object;
a deviation information acquisition unit that acquires deviation information for calculating at least one of: a deviation distance from a regulation distance of the inspection object in the image data, or a deviation angle from a regulation angle of the inspection object in the image data; and
an image correction unit that calculates at least one of the deviation distance or the deviation angle based on the image data and the deviation information and corrects the image data.

2. The inspection device according to claim 1, wherein
the deviation information acquisition unit acquires auxiliary image data including the inspection object, the auxiliary image data being imaged by an auxiliary wearable camera arranged in parallel and at equal height with the wearable camera, and
the image correction unit calculates at least one of the deviation distance or the deviation angle from the parallax of the inspection object in the image data and the auxiliary image data.

3. The inspection device according to claim 1, wherein
the deviation information acquisition unit acquires distance information of the inspection object based on a distance measuring light emitted at a predetermined angle to an optical axis of the wearable camera, and
the image correction unit calculates at least one of the deviation distance or the deviation angle from the image data and the distance information.

4. The inspection device according to claim 1, wherein
the deviation information acquisition unit acquires, as the deviation information, position specifying information imaged together with the inspection object in the image data, and
the image correction unit calculates at least one of the deviation distance or the deviation angle from a relative positional relationship between the inspection object and the position specifying information.

5. The inspection device according to claim 4, wherein
the position specifying information is a lattice-shaped pattern on a portion where the inspection object is placed.

6. The inspection device according to claim 4, wherein
the position specifying information is a known shape information of a portion where the inspection object is placed.

7. An inspection device for a worker that performs inspection work, comprising:
a wearable camera configured to be attached to the worker; and
a controller including a processor and a memory, the controller being coupled to the wearable camera, wherein
the controller is programmed to:
control the wearable camera to acquire image data of an inspection object,
analyze the acquired image data to measure a deviation information for the inspection object,
calculate, based on the deviation information, at least one of a deviation distance from a regulation distance of the inspection object in the image data or a deviation angle from a regulation angle of the inspection object in the image data, and
correct the image data based on the calculated deviation distance or deviation angle.
